(19) United States
(12) Patent Application Publication
(10) Pub. No.: US 2011/0056023 A1
(43) Pub. Date: Mar. 10, 2011

(54) SEATING AND BED SUPPORT DEVICES AND METHODS RELATED TO THE SAME

(76) Inventor: Gerald C. Weeks, San Juan Capistrano, CA (US)

(21) Appl. No.: 12/877,802

(22) Filed: Sep. 8, 2010

Related U.S. Application Data
(60) Provisional application No. 61/240,581, filed on Sep. 8, 2009.

(51) Int. Cl. A47D 15/00; A61G 7/065

(52) U.S. Cl. 5/652

(57) ABSTRACT

Seating and bed support devices for children and methods related to the same

### CROSS-REFERENCE TO RELATED APPLICATIONS

The present application claims the benefit of and priority to U.S. Provisional Patent Application Ser. No. 61/240,581, filed on Sep. 8, 2009, entitled SEATING AND BED SUPPORT DEVICES AND METHODS RELATED TO THE SAME, which is hereby incorporated by reference in its entirety.

### BACKGROUND

When infants and small children (“children”) are recovering from medical procedures they often are put onto pediatric or adult beds which fail to appropriately support their small dimensions. Further, these children often need to be positioned on partially-inclined surfaces, for example, where head and/or torso are inclined, to promote recovery and to avoid certain health risks such as rolling over and suffocating, Sudden Infant Death Syndrome (SIDS), or fluid buildup in the upper body. The placement of children at determined angles of inclination is further complicated when a child is unconscious or lacks the strength or coordination to position him/herself in a safe and comfortable position. Currently, care givers and/or medical staff have no suitable device or suitable and safe solution for properly supporting a child at an inclined angle.

### SUMMARY

The devices and methods disclosed herein each have several aspects, no single one of which is solely responsible for their desirable attributes. Without limiting the scope of the claims, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description of Certain Embodiments,” one will understand how the features of the devices and methods disclosed herein provide advantages over other known devices and methods.

Embodiments generally relate to seating and bed support devices and methods related to the same. Some particular examples are described in relation to use in a hospital or medical care setting. However, the concepts described can be used in a variety of settings, including the home.

Some embodiments relate to devices for elevating a child and/or maintaining the position of the child. For example, some aspects relate to child support devices that are capable being placed on partially-inclined surfaces (such as an inclinable hospital bed); that is configurable to the individual dimensions of the child; that provides support for the head, neck, torso, arms, and/or legs; and that maintains the child in a safe and comfortable position while in use. In some aspects the child support devices work with different angles of incline. The devices can be adjustable so that a single device can adjust for multiple angles. For example, if the device is used on a hospital bed, it can be used while the bed is flat, when it is inclined at 10 degrees, when it is inclined at 20 degrees, or when it is inclined at 45 degrees for example.

In one embodiment, the child support devices can include a back portion and a seat portion coupled by an attachment to allow movement of the back portion relative to the seat portion. Further, this embodiment can include one or more of side restraints, arm rests, an upper support, and a lower support that are attached to the back portion and seat portion using support attachment areas, where the same are configured to form an accommodation area suitable for a child.

In another embodiment, the child support devices can include a unitary structure, where the flexibility of part of, or the entirety of, the unitary structure allows a back portion to move relative to a seat portion. Further, this embodiment can include one or more of side restraint(s), arm rest(s), an upper support, and a lower support that are attached to the back portion and seat portion using support attachment areas, where the same are configured to form an accommodation area suitable to a child. In some aspects the various restraints, arm rests, and supports can be moved and attached to fit the size of a given child. Thus, the devices can be used for users of all different sizes, which can provide greater comfort and safety for the users.

In another embodiment, the child support devices can include a unitary structure, where the flexibility of part of, or the entirety of, the unitary structure allows a back portion to move relative to a seat portion. Further, this embodiment can include side restraints that extend from the back portion to the seat portion, an upper support, and a lower support that are attached to the back portion and seat portion using support attachment areas, where the same are configured to form an accommodation area suitable to a child. As mentioned above, in some aspects the various restraints, arm rests, and supports can be moved and attached to fit the size of a given child.

In another embodiment, the child support devices can include a bed cover or sheet, where the cover or sheet is configured to be placed over an inclinable bed such that a back portion can move relative to a seat portion. Further, this embodiment can include one or more of side restraint(s), arm rest(s), an upper support, and a lower support that are attached to the back portion and seat portion using support attachment areas, where the same are configured to form an accommodation area suitable to a child. As mentioned above, in some aspects the various restraints, arm rests, and supports can be moved and attached to fit the size of a given child.

Still other embodiments relate to methods for securing a child in a child support device placed on an inclinable bed. Some embodiments relate to methods for securing a child in support device placed on an inclinable hospital bed, which methods can include placing a child on any device described above and elsewhere herein.

In another embodiment, a kit including: a back portion; a seat portion configured to be coupled to the back portion; a plurality of supports configured to be attached to the back portion and the seat portion such that the plurality of supports provide an accommodation area for supporting a child, is provided. In some aspects the various supports can be moved and attached to fit the size of a given child. Also, some embodiments relate to kits. The kits can include, for example, one or more of a back portion; a seat portion configured to be coupled to the back portion; a plurality of supports configured to be adjustably attached to said back portion and said seat portion such that the plurality of supports provide an accommodation area for supporting a child; and support attachment areas for attaching the plurality of supports to said back portion and seat portion in a desired configuration. In some aspects the support attachment areas comprise hook-and-loop fasteners. In some aspects, one or more of the supports, attachments mechanisms or areas, rests, portions, etc. can be specifically excluded from the kits.

It should be noted that any of the various supports, arm rests, other rests, portions, and restraints described in the preceding paragraphs and elsewhere herein can be specifically excluded from some aspects. Those elements can be included in any combination or excluded individually or in any combination.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1A is a perspective view of one example of a child support device according to one embodiment.

FIG. 1B is a top view of one example of a child support device according to one embodiment.

FIG. 1C is a side view of one example of a child support device according to one embodiment.

FIG. 1D is an exploded perspective view of one example of a child support device according to one embodiment.

FIG. 2 is an exploded top view of one example of a child support device according to one embodiment.

FIG. 3A is a side view of another embodiment of one example of a child support device that includes a unitary structure.

FIG. 3B is a side view of another embodiment of one example of a child support device that includes a unitary structure.

FIG. 4 is a perspective view of one embodiment of one example of a child support device located on top of an inclinable hospital bed.

FIGS. 5A-C depict a perspective view of one example embodiment of a child support device with a removable covering.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Generally, embodiments described herein relate to seating and bed support devices and methods related to the same. Currently, care givers and/or medical staff have no suitable device or solution for supporting a child at an inclined angle. Medical staff must devote considerable time throughout the day to attempt to properly position and support a child. Such efforts work poorly, are uncomfortable, have health and safety risks, and require repeated repositioning, taking valuable staff time. Further, the constant repositioning and adjusting can interfere with the various intravenous lines, tubes, electrical leads, and other wiring that are used to treat and monitor the child. Perhaps worse, the use of the articles to create proper support for recovering children often conceals the smaller features of the child, such as fingers and toes, which can serve as important visual indicators of the child's vital signs.

By providing a child support device that is configurable to a child's unique size, and which can support one or more of the child's head, neck, arms, and/or legs, while maintaining a safe and comfortable position, a doctor, nurse or other type of care provider can focus on medical diagnosis and treatment rather than on constantly attending to the positioning of the child in a bed. In particular, the benefits of a proper support device for a recovering child can include, for example, prevention of possibly harmful movement, increased circulation to the extremities, reduced traction on elevated joints, proper exposure of the extremities for quick visual diagnostics, improved airway, and generally greater comfort and safety. Accordingly, some embodiments herein generally relate to child support devices capable of being placed on partially-inclined surfaces, as well as flat surfaces; that support a child's head, neck, arms, and/or legs; that are configurable to the individual dimensions of a child; and/or that can maintain a child in a safe and comfortable position while in use.

Some embodiments provide devices for supporting an infant or a small child (a “child”) on an inclinable bed or partially-inclined surface. In particular, certain embodiments address problems associated with existing inclinable beds that are not appropriately sized to correctly and comfortably support a child.

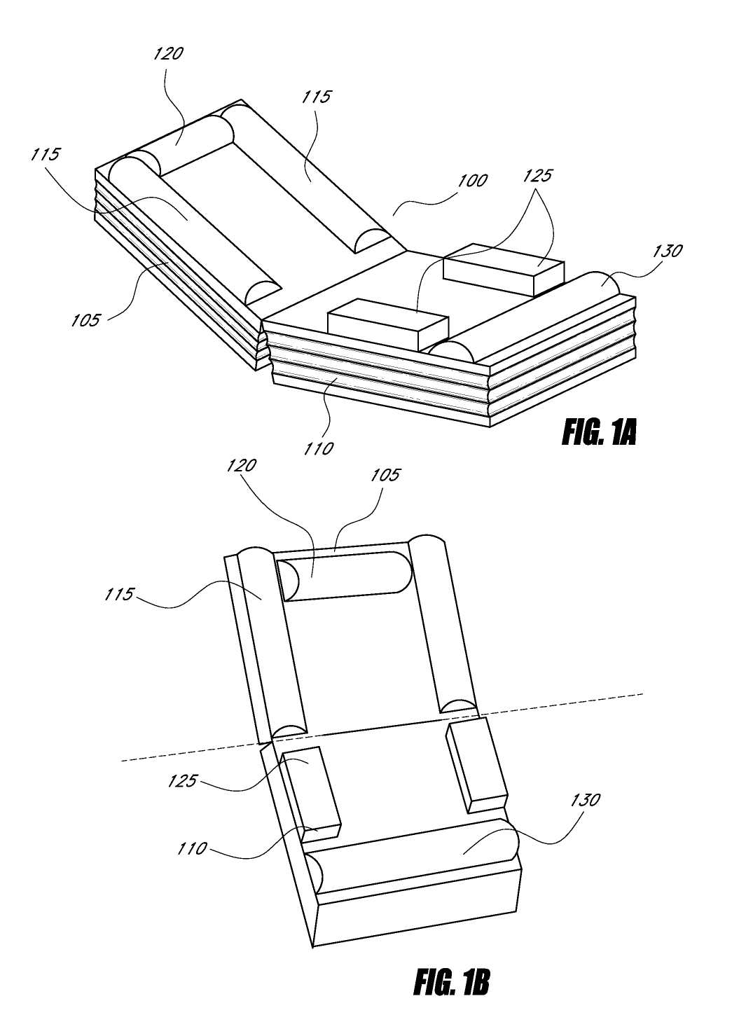

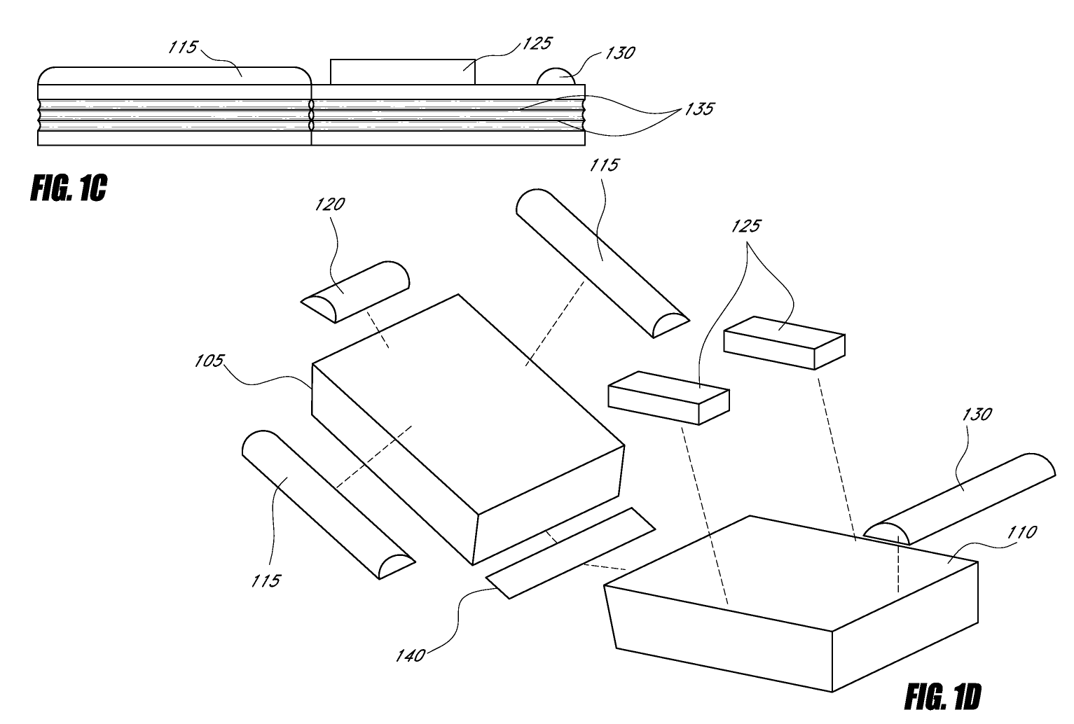

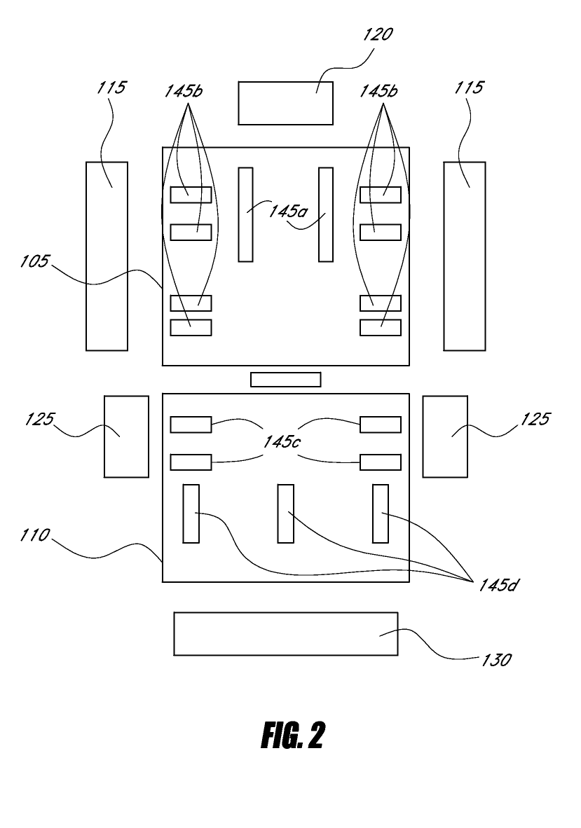

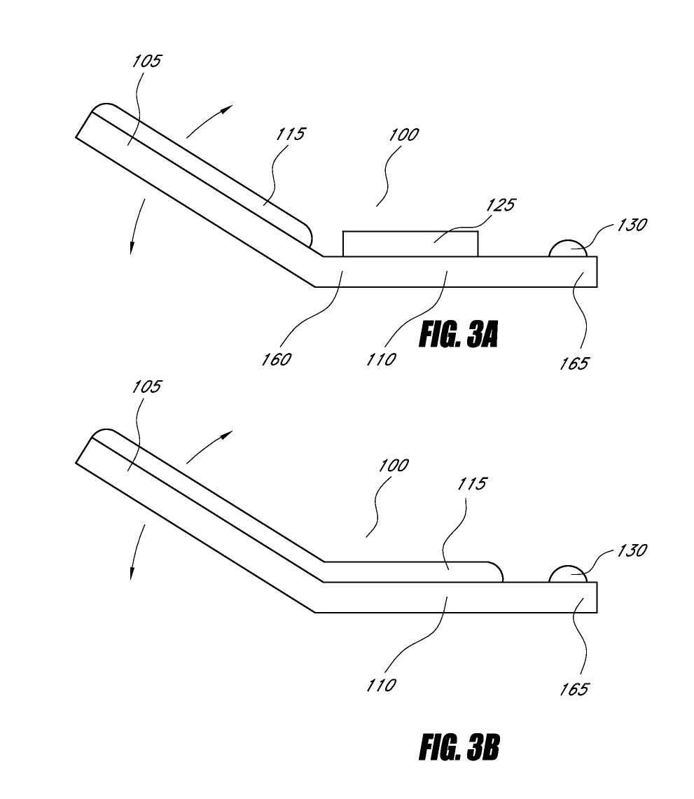

A first embodiment is described with respect to FIG. 1A, which schematically illustrates an infant support device 100 that includes a back portion 105, a seat portion 110, an attachment mechanism 140, two side restraints 115, two arm rests 125, an upper support 120, a lower support 130, support attachment areas 145 (not shown), and an accommodation area 150. It should be noted that although the side restraints and arm rests are shown as separate components, they can be combined to form a single component and/or one or the other can be excluded from various aspects. Also, it is worth noting that optional grooves 135 are depicted.

In the example of an embodiment illustrated by FIG. 1A, an upper support 120 is located on the back portion 105 and extends generally parallel to the top of the back portion 105. In the illustrated embodiment, the upper support 120 is made to fit between the side restraints 115 and is located so as to support the head and/or neck, reducing the likelihood of lateral movement. It should be understood that in other aspects the side restraints 115 can be shortened and the upper support 120 can be configured to extend even further, perhaps even to the edges of the device. Additionally, the upper support 120 provides anterior natural support for improving the airway. In the illustrated embodiment, the upper support 120 is rectangular along its length; however, it will be appreciated that the upper support 120 may be fashioned into any shape suitable for support. For example it can be rounded (similar to the depicted ellipsoidal lower restraint 130) to generally fit the contour of the neck of the patient. It should also be appreciated that the upper restraint 120 and the side restraints 115 can be a single component rather than three separate components.

In the embodiment illustrated by FIG. 1A, the side restraints 115 are located on the back portion 105 and extend generally parallel to the sides of the back portion 105. The side restraints 115 can prevent lateral movement of a child's head, shoulders, and torso, which can promote a better airway, for example. Based upon the instant disclosure, persons skilled in the art will understand that the side restraints 115 may be positioned either medially or laterally, depending on the size of the child. In the illustrated embodiment, the side restraints 115 are ellipsoidal along their length; however, it will be appreciated that the side restraint 115 may be fashioned into any shape suitable for support.

In the embodiment illustrated by FIG. 1A, arm rests 125 are located on the seat portion 110 and can permit a consistent position of the arms while reducing traction on the shoulder joints. Additionally, for embodiments used in a hospital setting, the arm rests 125 can improve the presentation of the arms and access to intravenous lines and other types of wiring and tubing typically used there. In the illustrated embodiment, the arm rests 125 are rectangular along their length; however it will be appreciated that the arm rests 125 may be fashioned into any shape suitable for support. For example, the arm rests 125 can be concave to help keep the arms from sliding off of the arm rest. As already noted, although the arm rests 125 are shown as separate components, the arm rests 125 and the side restraints 115 can be the same or form a single component.

In the embodiment illustrated by FIG. 1A, a lower support 130 is located on the seat portion 110 and extends generally parallel to the bottom of the seat portion 110. The lower support 130 may be placed so as to support the legs and/or knees of the child so as to prevent slippage of the child from a preferred orientation due to the effects of gravity, for example, while in an inclined position. Additionally, the lower support can aid in support of the lumbar spine and may increase circulation to the lower extremities. In the illustrated embodiment the lower support 130 is not located between the arm rests 125. In other embodiments, the arm rests 125 may be longer and the lower support 130 may be placed between them. Also, while depicted as separate components, the lower support 130 and the arm rests 125 can be formed as a single component. In the illustrated embodiment, the lower support 130 is ellipsoidal along its length; however it will be appreciated that the lower support 130 may be fashioned into any shape suitable for support.

In the embodiment illustrated by FIG. 1A, the back portion 105 and seat portion 110 include grooves 135 that extend generally parallel along the sides of the back portion 105 and seat portion 110. The grooves 135 are optional. For embodiments used in a hospital setting, the grooves 135 can be used to route and protect wires, tubes, and any other types of lines that is interfaced with the patient. It will be appreciated that the grooves 135 may be of any length and shape, and may be present on one or both sides of the back portion 105, the seat portion 110, or both. Similarly, the grooves can be placed in other directions, locations and/or combinations of directions, sizes and locations. In some aspects the grooves can pass complete through one or more parts of the device, for example, by forming a hole. In some aspects, the grooves can be replaced or supplemented by clips or other attachment mechanisms that aid in routing and/or protecting tubes, wires, etc. In some embodiments the devices can include a hole that permits passage of wires through the back portion 105 and/or the seat portion 110, for example. Again, as noted, the grooves are optional and may be excluded from some embodiments.

The device of FIG. 1A depicts an attachment mechanism 140. The attachment mechanism although shown generally in the middle of the junction of the back portion 105 and the seat portion 110, can be placed at any location in order to attach the back portion 105 to the seat portion 110. Any suitable configuration or mechanism can be used to couple the portions together and/or to permit movement of the portions relative to each other, for example. Various mechanisms and materials that can be utilized for the attachment mechanism 140 are described more fully below.

FIG. 1B illustrates a top view of one example of an embodiment of a child support device 100. The side restraints 115 and upper support 120 are positioned on the back portion 105, and the arm rests 125 and lower support 130 are positioned on the seat portion 110. In the illustrated embodiment, the side restraints 115, arm rests 125, upper support 120, and lower support 130 are positioned relative to one another to form an accommodation area 150 (oval area shows the general area in the central region where the child may sit). It will be appreciated that altering the location of the side restraints 115, upper support 120, arm rests 125, and lower support 130, advantageously allow the adjustment of the accommodation area 150 to the dimensions of a child so as to maximize support and comfort. The various described components can be moved in order to fit the particular child using the device. In some embodiments, one or more of the components can be excluded. In some embodiments one or more of the components can be formed together, rather than as separate pieces.

FIG. 1C illustrates a side view of an example of a first embodiment of an infant support device 100 lying flat. It will be understood that a child positioned in the accommodation area 150 (not depicted in FIG. 1C) can lie flat, or if the device were raised the infant could be inclined at any desired angle. The device in the flat orientation shown in FIG. 1C depicts a side restraint 115 and an arm rest 125 on one side of the device, and also depicts the end of a lower support 130. Although not depicted, the device illustrated in FIG. 1C can include grooves or holes for routing/protecting of wires or tubes.

FIG. 1D shows an exploded view of an example of an embodiment of the infant support device 100 that includes side restraints 115, an upper support 120, arm rests 125, a lower support 130, and attachment mechanism 140. In FIG. 1D the attachment mechanism 140 couples the back portion 105 with the seat portion 110. The coupling can be configured, for example, so that the back portion 105 may be inclined relative to the seat portion 110. The attachment means 140 advantageously can allow the child support device 100 to rest securely on various inclined surfaces, including for example, inclinable hospital beds, while limiting lateral motion of the back portion 105 relative to the seat portion 110. In the illustrated embodiment, the attachment mechanism 140 can be a piece of fabric which extends along at least part of the length of the top edge of the seat portion 110 and bottom edge of the back portion 105, for example. In some aspects, it can extend the entire length of the seat portion 110 and bottom edge of the back portion 105, for example.

Based upon the instant disclosure, persons skilled in the art will understand that the attachment mechanism 140 can be made of a single piece of material or more than one piece of material (e.g., fabric). The attachment mechanism 140 may be of any shape and size suitable to allow attachment of the back portion 105 to the seat portion 110 and/or to permit inclination of the back portion 105 relative to the seat portion 110 while preventing lateral movement of the back portion 105 relative to the seat portion 110. In other embodiments, there may be a plurality of attachment mechanism suitable to the same requirements as mentioned above. Additionally, based upon the instant disclosure, persons skilled in the art will understand that the attachment mechanism 140 may be made of any suitable material, including for example, suitably flexible and durable material such as organic fabrics, inorganic fabrics, polymer materials, plastics, combinations of the same and the like. Also, the attachment mechanism can include, for example, one or more hinges, loops, or other rotatable mechanisms. The attachment mechanism 140 can be attached to the back portion 105 and seat portion 110, for example, with a non-toxic adhesive, hook-and-loop fasteners, double-sided tape, other suitable adhesives, rivets, staples, combinations thereof, and the like.

It will be appreciated from the exploded view of the child support system 100 in FIG. 1D that the side restraints 115, upper support 120, arm rests 125, and lower support 130 may be configured at various spacing relative to one another such that the accommodation area 150 is configured to best fit the child.

FIG. 2 illustrates a top exploded view of an example of an embodiment of an infant support device 100. In the illustrated embodiment, a plurality of support attachment areas 145 are positioned on the back portion 105 and seat portion 110 of the child support device 100. The support attachment areas 145 allow the upper support 120, side restraints 115, arm rests 125, and lower support 130 to be attached to the child support device 100. It will be appreciated that any number of support attachment areas 145 may be present on the child support device 100 and they may be spatially arranged in a variety of ways such that the side restraints 115, upper support 120, arm rests 125, and lower support 130 may be attached to form an accommodation area 150 that is best fit for a particular child. In one embodiment, the support attachment areas 145 are can include hook-and-loop fasteners that allow for the easy attachment and reattachment of the various supports to fit different children. It will be appreciated that where an embodiment uses hook-and-loop fasteners for the support attachment areas 145, either the hook or the loop side of the fastener may be used on the back portion 105, the seat portion 110, or both, with the corresponding hook or loop fastener on the bottom of the support, restraint, or rest being attached. Any other suitable fastening mechanisms also can be used, including for example, Velcro®, buttons, snaps, clips, adhesives, and the like. In some embodiments, side attachment points 145 may be the surface of the back portion 105 and attach to a surface of the side restraints 115 that include an attachment mechanism. In some aspects, large areas, or significantly all of the surface of the back and/or seat portions can have a fastening mechanism permitting the positioning of the various components and almost any position, angle, distance, etc. For example, the soft side of Velcro® can be attached to some or all of the seat and/or back portions permitting the attachment of the various components, which have the opposite part of the Velcro®.

In the embodiment illustrated by FIG. 2, there are support attachment areas 145a that extend generally parallel to the sides of the back portion 105 to allow the attachment of the upper support 120 at various distances from the top of the back portion 105. For example, to accommodate a taller child, the upper support 120 may be attached closer to the top of the back portion 105. Alternatively, to accommodate a shorter child, the upper support 120 may be attached farther from the top of the back portion 105.

Also in the illustrated embodiment, a plurality of support attachment areas 145b extend generally perpendicular to the sides of the back portion 105 and allow the side restraints 115 to be attached at various distances from the sides of the back portion 105. For example, to accommodate a narrower child, the side restraints 115 may be attached to the support attachment areas 145 closer to the center of the back portion 105. Alternatively, to accommodate a wider child, the side restraints 115 may be attached closer to the sides of the back portion 105. In other embodiments, the side restraints 115 may be attached at an angle relative to the side of the back portion 105.

Likewise in the illustrated embodiment are a plurality of support attachment areas 145c that extend generally perpendicular to the sides of the seat portion 110 to allow attachment of the arm rests 125 at various distances from the side of the seat portion 110. For example, to accommodate a thinner child, the arm rests 125 may be attached closer to the center of the seat portion 110. Alternatively, to accommodate a child with a wider body, the arm rests may be attached closer to the sides of the seat portion 110. In other embodiments, an arm rest 125 may be attached at an angle relative to the side of the seat portion 110.

Finally, in the illustrated embodiment are a plurality of support attachment areas 145d that extend generally parallel to the sides of the seat portion 110 to allow the lower support 130 to attach at various distances from the distal end of the seat portion 110. For example, to accommodate a child with longer legs, the lower support 130 may be attached closer to the distal end of the seat portion 110. Alternatively, to accommodate a child with shorter legs, the lower support 130 may be attached farther from the distal end of the seat portion 110. In preferred embodiments, the lower support 130 is positioned under the popliteal fossa, the posterior aspect of the knee, to improve circulation to the lower extremities.

It will be appreciated from the illustrated embodiment in FIG. 2 that any of the side restraints 115, upper support 120, arm rests 125, or lower support 130 may be configured to accommodate the size of a child. Also, it should be noted that one or more of the attachment areas can be excluded if desired. Further, in some aspects, one or more of the components of the device 100 can be specifically excluded from the devices, kits and methods, for example, one or more of components 105-145 of FIGS. 1-2.

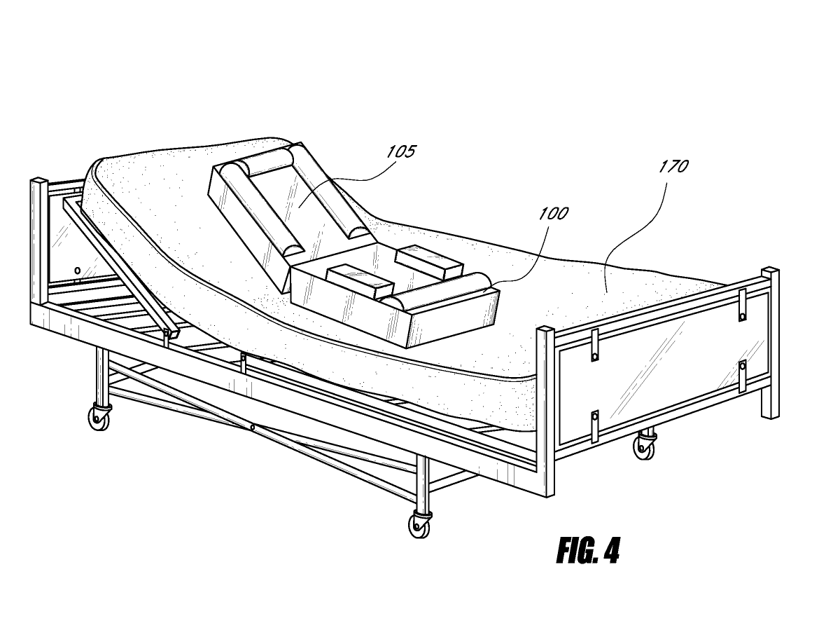

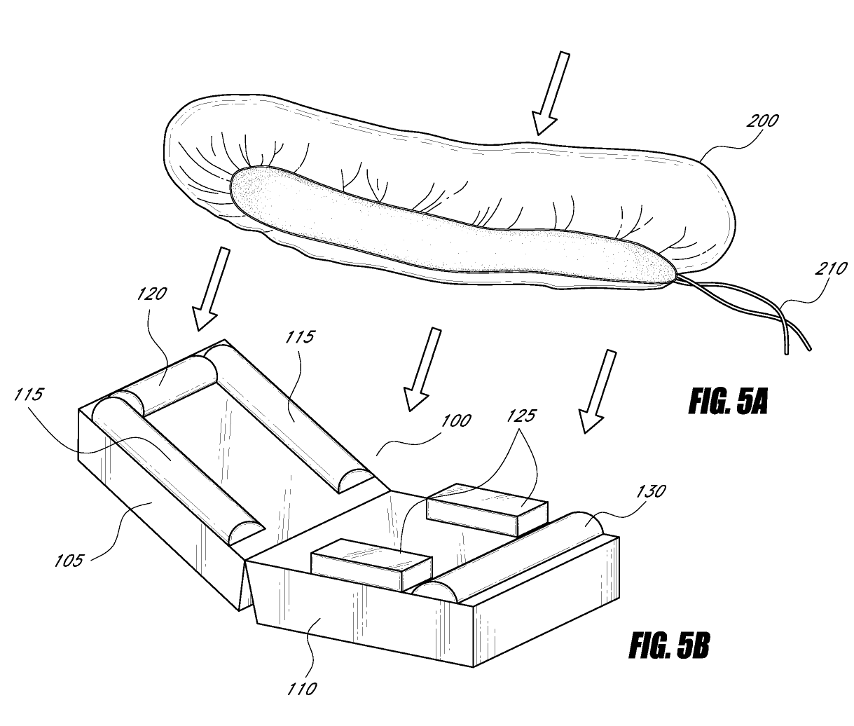

FIGS. 3A and 3B are side views of an example of a child support device 100 according to another embodiment. FIG. 3A, shows a “unitary” structure 165 that includes a back portion 105 and a seat portion 110 wherein the back portion 105 can be inclined to an angle relative to the seat portion 110. In the illustrated embodiments, the unitary structure 165 can be a formed, for example, of a flexible, pliable or bendable material. For example, the unitary structure 165 can be made of polyurethane and may be of a variety of thicknesses. In other embodiments, the unitary structure may be a bed sheet or other covering that can be secured to a bed. Although, the depicted device is described as using polyurethane, any other suitable material and/or fabric can be used.

The embodiment illustrated in FIGS. 3A and 3B has no need for an attachment mechanism 140 because the back portion 105 and the seat portion 110 are already connected by virtue of being part of a unitary structure; rather, the movement of the back portion 105 relative to the seat portion 110 is accomplished by bending, moving or flexing the flexible unitary structure. Persons skilled in the art will appreciate that the unitary structure can be flexible throughout or flexible only in an area that allows suitable movement of the back portion 105 with relative to the seat portion 110.

As illustrated in illustrated in FIGS. 3A and 3B, side restraints 115, an upper support 120 (not shown), arm rests 125, and a lower support 130 may be attached to the back portion 105 and seat portion 110 of the unitary structure 165 using suitable support attachment areas 145 (not shown) and configured to best fit a child.

FIG. 3B shows another embodiment where the side restraints 115 extend from the back portion 105 to the seat portion 110 and are flexible so as to allow inclination of the back portion 105 relative to the seat portion 110. In this embodiment, the side restraints 115 serve the purpose of arm rests without the need for an additional attachment.

Further, in some aspects, one or more of the components of the device 100 can be specifically excluded from the devices, kits and methods, for example, one or more of components 105-165 of FIGS. 3A and 3B.

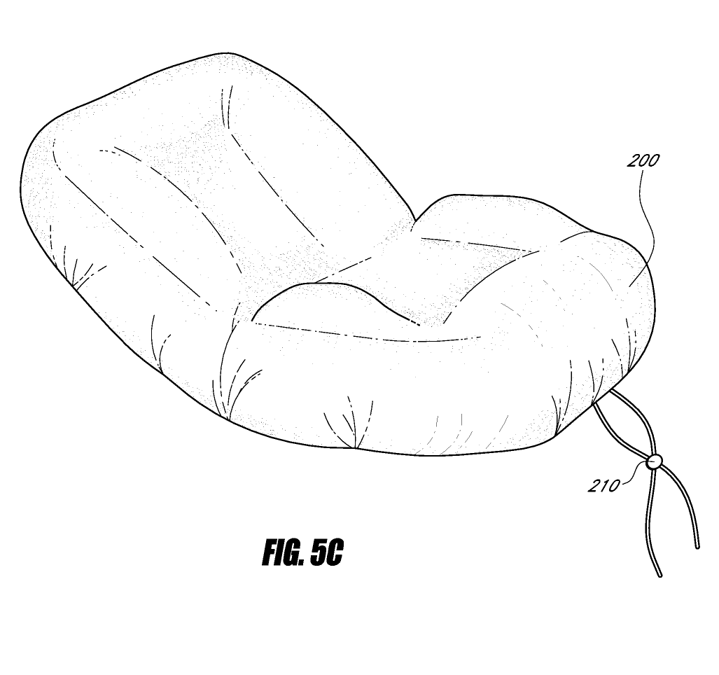

FIG. 4 illustrates a perspective view of a child support device 100 positioned on an inclinable hospital bed 170. It will be appreciated that the back portion 105 may be inclined with the angle of inclination of the hospital bed 170. Further, it will be appreciated that the illustrated embodiment of the child support device 100 and aspects thereof may be removable and positioned on a diversity of inclinable beds, inclinable furniture, or other partially-inclined surfaces.

It is contemplated that any embodiments may be covered in a suitable material, such as, for example, a cotton or polyester fabric. While a covering is not necessary for the proper function of the child support device 100 described herein, a covering can be advantageous in that it can increase the level of comfort and safety of the child support device 100. Further, it is contemplated that the covering could be permanent or removable. A removable covering may have the advantage of being washable. Particularly where embodiments of the child support device 100 are used in a hospital setting, a washable covering can help maintain a sterile environment for recovery. Finally, it is contemplated that the covering material can be such that a hook-and-loop type fastener could attach directly to it without need for additional support attachment areas.

Further, in some aspects, one or more of the components of the device 100 can be specifically excluded from the devices, kits and methods, for example, one or more of components 105-170 of FIG. 4.

FIGS. 5A-5C illustrate an example of an embodiment that includes a covering. FIG. 5A depicts a covering 200 that includes a securing mechanism 210 that secures the covering 200 to the device 100. FIG. 5B depicts the device 100 to which the covering 200 is to be secured. FIG. 5C depicts the device with the covering 200 secured onto the device. The covering in the depiction fits over the device 100. The covering 200 also can be washable. A child can lie on top of the covering 200. The covering 200 can act as a barrier between the child and one or more of the following: side restraints 115, arm rests 125, upper support 120, lower support 130, and the upper portion 105 and lower portion 110 of the device 100. As depicted in FIG. 5C, the previously mentioned supports are covered by the covering 200. The covering 200 may be secured with elastic similar to that of a common bed sheet, draw string or any other suitable mechanism.

It some embodiments, the various supports can be covered by a material, for example, a separate “breathable, yet water repellent” fabric that encloses each support individually. The fabric, regardless of what it is made of can encase the supports, for example supports made of polyurethane foam, and can close with a zipper, Velcro®, buttons, or any other suitable mechanism. In the embodiments that include individually enclosed supports, an additional covering as depicted in FIGS. 5A-5C also can be used. The material for the covering 200 in 5A-5C can be the same or different from the covering used to cover the individual supports. In some aspects, coverings can be excluded from the devices.

In any of the described embodiments, the devices further can optionally include straps, belts, harnesses, etc. for strapping the child to the devices. For example, the devices can include straps to prevent the child from falling forward while the device are inclined. In some aspects shoulder straps, harnesses, or a seat belt can be utilized. In some aspects, the devices and methods can specifically exclude straps, belts, harnesses, etc.

In all of the illustrated embodiments, the back portion 105, seat portion 110, the unitary structure 165, side restraint 115, arm rest 125, upper support 120, and lower support 130 can be made of any suitable material. In some embodiments they can be made of polyurethane, for example. In other embodiments one or more of the components can be made of foam, plastic, sponge, pillow-like material (e.g., down feathers, memory foam, etc.), inflatable material, and the like. In view of the disclosure, those skilled in the art will understand that other embodiments could be made of any similarly resilient material.

It is further contemplated that an advantage of certain embodiments is efficient storage. In some embodiments, such as those shown in FIGS. 1A-D, 2, 3A-B, 4 and 5A-C, the upper support 120, side restraints 115, arm rests 125, and lower support 130 are detachable. When detached from embodiments such as those illustrated in FIGS. 1A-D, 2, and 4, the attachment means 140 allows for the back portion 105 to be rotated all the way on top of the seat portion 110, so that the back portion 105 lies inverted on top of the seat portion 110. Likewise, where embodiments, such as for example, those shown in FIGS. 1A-D, 2, and 4, that use removable attachment mechanisms 140, the back portion 105 and seat portion 110 may simply be stacked together. In both cases, the “footprint” of the device for storage is reduced. Similarly, when the upper support 120, side restraints 115, arm rests 125, and lower support 130 are detached from embodiments that use a unitary structure 165, such as those illustrated in FIGS. 3A-B, the unitary structures may be stacked with each other or rolled as appropriate to be more efficiently stored.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device for supporting a child in an inclinable bed, comprising:
a seat portion;
a back portion movable relative to the seat portion, wherein the back portion is movable between at least a first position wherein the back portion is substantially parallel to the seat portion and a second position wherein the back portion is inclined at an angle relative to the seat portion;
a side restraint extending at least part of the length of the back portion, the side restraint being generally parallel to the side of the back portion;
an arm rest extending at least part of the length of the seat portion, the arm rest being generally parallel to the side of the seat portion;
a lower support extending across the seat portion generally perpendicular to the side restraints when the back portion is in said first position; and
an upper support extending across the back portion.

2. The device of claim 1, wherein the back portion is coupled to the seat portion, such that the back portion may be inclined relative to the seat portion.

3. The device of claim 1, wherein the device comprises a unitary structure, wherein a first portion of the structure comprises the back portion, and a second portion comprises the seat portion, and wherein at least a portion of the structure is flexible to permit movement of the back portion relative to the seat portion.

4. The device of claim 1, comprising a plurality of side restraints which extend along at least part of the length of the back portion.

5. The device of claim 4, further comprising a plurality of arm rests secured to the seat portion.

6. The device of claim 1, comprising a plurality of arm rests which extend along at least part of the length of the seat portion.

7. The device of claim 6, further comprising a plurality of side restraints which extend along at least part of the length of the back portion

8. The device of claim 1, wherein at least one of the side restraints, the lower support, and upper support is adjustably attached to at least one of the back portion and seat portion of the device.

9. The device of claim 8, wherein the lower support is adjustably attached to the seat portion.

10. The device of claim 8, wherein the upper support is adjustably attached to the back portion.

11. The device of claim 8, wherein the side restraints are adjustably attached to one or both of the back portion and seat portion.

12. The device of claim 8, wherein said at least one of the side restraints, the lower support, and upper support is attached to at least one of the back portion and seat portion of the device by support attachment areas.

13. The device of claim 12, wherein the support attachment areas further comprise hook and loop fasteners.

14. The device of claim 12, wherein the support attachment areas are selected from the group consisting of buttons, snaps, ties, and zippers.

15. The device of claim 1, wherein one or both of the seat portion and the back portion have at least one groove extending generally parallel along at least part of one or more sides of said one or both of the seat portion and the back portion.

16. The device of claim 1, wherein the device is sized such that the upper support can support a child's neck while the lower support is positioned under the leg of the child.

17. The device of claim 1 wherein at least one component is covered by a material.

18. A device for supporting a child in an inclinable hospital bed, comprising:
an inclinable hospital bed, comprising a first portion and a second portion movable relative to one another; and
a removable device for supporting a child placed over the first and second portion of the hospital bed, comprising:
a seat portion,
a back portion,
and a plurality of support structures disposed on said seat portion and back portion, said plurality of support structures defining an accommodation area for a child, the accommodation area extending over at least a portion of each of said seat portion and back portion, wherein the angle of incline between the seat portion and back portion is determined by the movement of the first portion relative to the second portion of the hospital bed.

19. A method for securing a child in a child support device placed on an inclinable bed, comprising placing a child on the device of claim 1.

20. The method of claim 19, further comprising adjusting at least one of the side supports, upper support, and lower support to secure the child.
